(19) United States
(12) Patent Application Publication
(10) Pub. No.: US 2008/0095259 A1
(43) Pub. Date: Apr. 24, 2008

(54) Pre-coding for multiple-input-multiple-output communications

(76) Inventors: Justin S. Dyer, Manhattan, KS (US); Balasubramaniam Natarajan, Manhattan, KS (US)

Correspondence Address: Steven J Shattil, P.O. Box 17355, Boulder, CO, 80308-0355, US

(21) Appl. No.: 11/585,061

(22) Filed: Oct. 23, 2006

(51) Int. Cl. H04L 23/02

(52) U.S. Cl. 375/265

(57) ABSTRACT

Precoding codes for MIMO transmitters are generated using an asymptotically optimal decoding algorithm, such as a trellis-exploration algorithm similar to the Viterbi algorithm. A trellis may be constructed using a number of desired subchannels, at least one code length, and a number of code-chip parameters. A fitness function is derived from a mathematical relationship between codes, and may include some measure of correlation of the codes. The selected codes correspond to paths having optimal path metrics derived from the fitness function. Multiple iterations through the trellis may be performed to refine a selection of the codes.

### BACKGROUND

1. Field of the Invention

The present invention relates generally to wireless networks, and more specifically to wireless networks that utilize multiple spatial channels and employ an asymptotically optimal decoding algorithm for generating spatial multiplexing codes.

2. Discussion of the Related Art

When wireless transceivers operate in an environment with many reflectors, received signals may arrive from different paths. This condition is known as multipath. Wireless transceivers may utilize multiple antennas to exploit multipath for increasing the communications bandwidth. For example, in some embodiments, wireless transceivers may communicate using Multiple-Input-Multiple-Output (MIMO) techniques. In general, MIMO systems offer higher capacities by utilizing multiple spatial channels made possible by multipath.

MIMO systems may operate either in open-loop or closed-loop modes. In open loop MIMO systems, a wireless transceiver estimates the state of the channel without receiving channel state information directly from another wireless transceiver. In general, open-loop systems employ exponential decoding complexity to estimate the channel. In closed-loop systems, communications bandwidth is utilized to transmit current channel state information between transceivers, thereby reducing the necessary decoding complexity, but also reducing overall throughput.

A transmitter may apply a pre-coding matrix P to a transmission signal for beamforming. The columns of a desired pre-coding matrix P may be viewed as transmit beamforming vectors because they give the direction of strong paths between the transmitter and a receiver. The resulting I/O model is expressed by

y=HPx+n,

where y is the received signal, x is the transmitted signal vector from the transmitter's antenna array, H denotes an N×N channel matrix, and n is additive white Gaussian noise with zero mean. If fewer than N spatial channels are to be used, the number of columns in P may be reduced by the number of unutilized spatial channels.

The pre-coding matrix P is typically selected to minimize or reduce cross correlation between different spatial subchannels. Thus, pre-coding in a MIMO system embodies objectives and principles that may be similar to at least some of those related to multiple-access coding in Code Division Multiple Access (CDMA) systems, such as direct-sequence CDMA (DS-CDMA), multi-carrier CDMA, multi-code CDMA, spread-OFDM, and other types of CDMA systems.

In practice, decoding errors are minimized by using distinctive multiple-access codes with suitable autocorrelation and cross-correlation properties. The cross-correlation between any two code subspaces should be low for minimal interference. At the same time, it is desirable for the autocorrelation property of a multiple-access code to be steeply peaked, with small side-lobes. Maximally peaked code autocorrelation yields optimal acquisition and synchronization properties for communications. Unfortunately, favorable autocorrelation characteristics are typically achieved at the expense of cross-correlation characteristics, and vice versa.

Code selection typically involves a trade-off between autocorrelation and cross-correlation performance. Various code-design techniques are described in D. V. Sarwate, “Mean-square correlation of shift-register sequences,” Proc. IEEE, vol. 131(2), April 1984, pp. 795-799, K. Yang, et. al., “Quasi-orthogonal sequences for code-division multiple-access systems,” IEEE Trans. Inform. Theory, vol. 46, pp. 982-992, May 2003, in P. V. Kumar and O. Moreno, “Prime-phase sequences with periodic correlation properties better than binary sequences,” IEEE Trans. Inform. Theory, vol. 37, pp. 603-616, May 1991, and in I. Oppermann and B. S. Vucetic, “Complex spreading sequences with a wide range of correlation properties,” IEEE Trans. Commun., vol. 45, pp. 365-375, November 1997, which are hereby incorporated by reference.

Various code-selection techniques have been developed, including artificial-intelligence approaches to complex signature sequence estimation, such as described in E. Buehler, B. Natarajan, and S. Das, “Multiobjective genetic algorithm based complex spreading code sets with a wide range of correlation properties,” in Proc. 15th International Conference on Wireless Communications, Vol. 2, Calgary, Alberta, Canada, 2003, pp. 548-552, and in B. Natarajan, S. Das, and D. Stevens, “Design of Optimal Complex Spreading Codes for DS-CDMA Using an Evolutionary Approach,” in Proc. Global Communications Conference, Dallas, November 2004, which are hereby incorporated by reference.

### SUMMARY OF THE INVENTION

In view of the foregoing background, embodiments of the invention may adapt an asymptotically optimal decoding algorithm to provide for constructing and/or updating a pre-coding matrix in a MIMO system. For example, some embodiments of the invention may employ a trellis-exploration algorithm similar to a Viterbi algorithm (such as described in A. J. Viterbi, “Error bounds for convolutional codes and an asymptotically optimal decoding algorithm”, IT, Vol. 13, 1967, pp. 260-269, and in A. J. Viterbi, CDMA: Principles of spread spectrum communication. Reading, Mass.: Addison-Wesley Publishing Company, 1995, which are hereby incorporated by reference.)

The Viterbi algorithm is a recursive solution to the problem of estimating the state sequence of a discrete-time finite-state Markov process observed in memoryless noise. Trellis-exploration algorithms, such as Viterbi decoding, are not restricted to decoding convolutional codes, but can be applied to other sequence-estimation problems, such as channel equalizers. Embodiments of the present invention may employ a trellis-exploration algorithm similar to the Viterbi algorithm (and other asymptotically optimal decoding algorithms) to design spatial multiplexing codes (e.g., beam-forming weights) having at least one predetermined attribute.

A trellis-exploration algorithm selects a path through a trellis (i.e., a state-transition diagram) that represents the most likely sequence that was generated by a convolutional encoder. At each symbol period, the algorithm generates a branch metric, which is a measure of probability for each branch. A collection of branches through the trellis from a beginning node to an end node is typically referred to as a path. The best path of each state is then determined by examining the accumulated metrics from all paths entering the state and selecting the one with the best metric. Paths with errors accumulate lower metrics, and thus, are discarded, leaving only the path that represents the sequence most likely generated by the convolutional coder.

Embodiments of the invention provide for metrics, such as correlation metrics, that characterize one or more predetermined relationships between pre-coding values for a given code set being constructed. One embodiment of the invention employs a mean-square aperiodic cross-correlation. In another embodiment of the invention, an average mean-square autocorrelation is employed. Yet another embodiment uses a maximum aperiodic cross-correlation. Alternative embodiments of the invention may employ any of a variety of measures to evaluate correlation characteristics of the spreading sequences and/or alternative signal parameters, such as peak-to-average power.

Embodiments of the invention may be configurable with any type of MIMO system, including, but not limited to, MIMO-OFDM, layered space-time MIMO systems, and MIMO systems employing space-frequency spreading. However, embodiments of the invention are not intended to be limited to such systems, as other coded signals may benefit from aspects of the invention.

One embodiment of the invention may employ multiple objectives for pre-coding selection, including spreading to reduce PAPR. Alternatively, other objectives may be employed. Embodiments of the invention may provide an iterative approach for calculating a pre-coding matrix without performing a singular value decomposition. Embodiments of the invention may provide for an iterative approach for updating a pre-coding matrix. For example, spatial processing may be adapted for changes in the number of spatial subchannels. Furthermore, embodiments of the invention may be configured to realize alternative advantages and objectives, as will be apparent to one skilled in the related art.

Some embodiments of the invention may provide for multiple iterations through the trellis. For example, a first pass through the trellis may employ incomplete information about the codes if the codes are constructed during the first pass. Subsequent passes through the trellis typically employ complete code sets. Thus, branch metrics may be more complete for subsequent passes in the sense that the metrics are based on complete code sets having a full code length for each code rather than partial code lengths and/or otherwise incomplete code sets. Accordingly, method and apparatus embodiments of the invention may be configured to update or improve an existing code set with respect to at least one set of metrics. Code construction may be performed as an iterative procedure comprising multiple passes through a trellis until some predetermined criteria (e.g., a performance measure and/or a number of iterations) is achieved.

The invention is not limited to particular types of communication systems. For example, embodiments of the invention may be implemented within wireless LAN, Wi-Max, satellite, waveguide, optical free-space, and Ultra-Wideband systems. Embodiments of the invention may also be configured to operate in remote-sensing systems, such as Radars, Lidars, RF tagging, and sensor networks.

Embodiments of the invention may be configurable for generating code sets, updating code sets, and/or reassigning subchannel codes in response to demand for network resources, changes in the number of users accessing the network, individual user-access requirements, changes in signal-propagation characteristics (e.g., multipath, Doppler, path loss, etc.), and/or interference (e.g., ISI, MAI, jamming, etc.). Embodiments of the invention may provide for flexible code lengths, sub-array processing, multiple levels of Quality of Service, and/or allow for system overloading. Embodiments of the invention may be optimized for minimum processing complexity, such as to enable suitability for real-time applications, rapid updates, low power consumption, and/or low cost processing components. Particular embodiments of the invention may be configured to provide for the previously recited features and advantages and/or alternative features and advantages.

These and other embodiments of the invention are described with respect to the figures and the following description of the preferred embodiments.

### BRIEF DESCRIPTION OF THE DRAWINGS

Embodiments according to the present invention are understood with reference to the following figures:

FIG. 1A shows a block diagram of a MIMO-OFDM system in accordance with an exemplary embodiment of the invention.

FIG. 1B shows a block diagram of a MIMO system employing space-time coding in accordance with an exemplary embodiment of the invention.

FIG. 1C illustrates a MIMO system configured to perform eigenmode transmission.

FIG. 2 illustrates an exemplary method embodiment of the invention configured for multiple-access code generation.

FIG. 3 is a trellis diagram in accordance with an exemplary embodiment of the invention.

FIG. 4 illustrates a method embodiment of the invention employing multiple iterations through a trellis.

FIG. 5 shows a block diagram of a multiple-access coder according to one embodiment of the invention.

FIG. 6 illustrates software components of a multiple-access coding embodiment of the invention residing on a computer-readable memory.

### DESCRIPTION OF THE PREFERRED EMBODIMENTS

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the spirit and scope of the invention as defined by the claims.

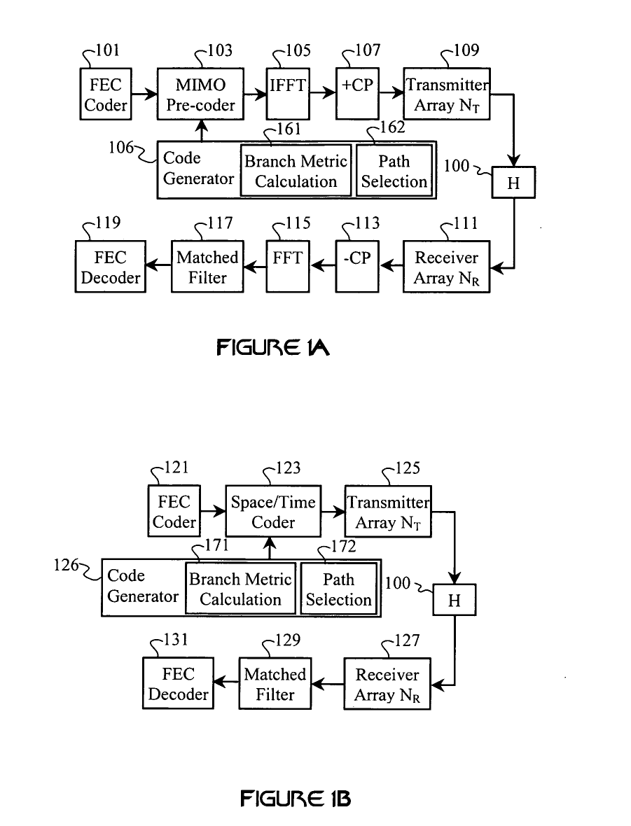

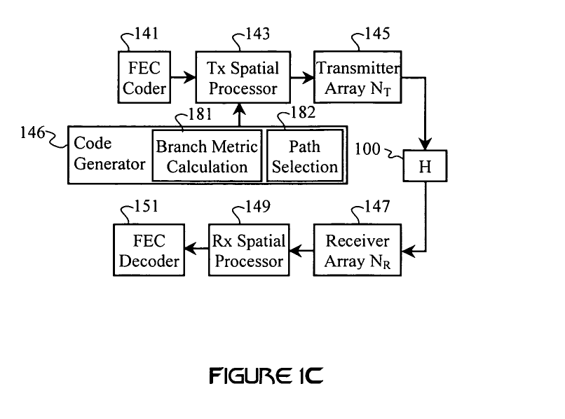

FIG. 1 shows a block diagram of a MIMO-OFDM system in accordance with an exemplary embodiment of the invention. A forward-error-control (FEC) coder 101 is configurable to provide channel coding (e.g., convolutional coding, block error-correction coding, etc.) to at least one user data stream. A pre-coder 103 applies spatial or space-frequency pre-coding to each user's data stream. Spatial precoding comprises an application of channel codes across a plurality of transmit antennas for each OFDM tone. Space-frequency pre-coding comprises channel coding across multiple OFDM tones, in addition to coding across a plurality of antennas. The pre-coder 103 comprises a code generator 106 employing a trellis-exploration algorithm configured to produce pre-coding code sets.

The code generator 106 comprises a branch-metric calculation module 161 configured for calculating branch metrics based on at least one fitness function for possible state transitions between two successive states. The code generator 106 further comprises a path-selection module 162 configured for calculating, as a function of the branch metrics, path metrics for possible paths constituted by successive state transitions that end in each of the states. The path-selection module 162 is also configured for selecting, for each of the states, the path having the optimal path metric. This optimal path determines the spatial or space-frequency code sets.

An inverse fast Fourier transform (IFFT) 105 modulates the coded data onto a predetermined set of orthogonal subcarriers, and a cyclic prefix is added 107 to the resulting modulated multicarrier signal. A transmitter array comprising a plurality N_{T} of transmit antennas couples the multicarrier signal into a communication channel 109, denoted by channel matrix H. A receiver 111 comprising an array of N_{R} receive antennas couples received signals from the channel 109. The received signals are processed by a cyclic-prefix remover 113, a fast Fourier transform (FFT) 115, and a matched filter 117 prior to processing by an FEC decoder 119.

For each frequency subchannel in a MIMO-OFDM system employing only spatial spreading, a received signal at an N_{R}-element receiver array is expressed by

r=HPb=H_{eff}b,

where b is an N_{T}×1 transmitted symbol vector, P is an N_{T}×N_{T} spatial pre-coding matrix that spreads each symbol vector across the N_{T} transmit antennas, H is an N_{R}×N_{T} channel matrix characterizing the propagation channel between the N_{T} transmit antennas and the N_{R} receive antennas, and H_{eff} is an N_{R}×N_{T} matrix comprising a product of the matrices H and P.

Due to the computational complexity of inverting H_{eff}, and by virtue of the relative temporal stability of the channel, an iterative solution is easily employed at the receiver. Typically, parallel or serial interference cancellation is employed. In OFDMA systems, channel precoding is an attractive option, since each user employs all of the spatial subchannels within their allocated frequency subchannel(s).

Parallel interference cancellation already employs a channel-correlation matrix R_{CC}=H_{eff}H_{eff}^{H}. Thus, an optimal pre-coding matrix S may be calculated using a trellis-exploration algorithm or a similar search algorithm employing a fitness function that is a function of the eigenvalues of R_{CC}. For example, since the similarity in eigenvalues of R_{CC} denotes system capacity, a path through the trellis may be selected based on candidate P-matrix values that minimize differences between the eigenvalues. Similarly, mean square error may be used as a fitness function to be minimized by path selection through the trellis. Other fitness functions may be used as well. Either the receiver or the transmitter may calculate the precoding matrix P.

If wireless terminals in the communication system employ time-division duplexing to use the same subcarrier frequencies for uplink and downlink, and the channel is slowly varying, the forward and reverse channels may be approximately equal. Thus, a pair of wireless terminals communicating with each other may calculate respective preceding matrices jointly without having to exchange channel information.

In another embodiment, a user may employ multiple subcarrier frequencies, and precoding (e.g., spreading) may be performed across the subcarrier frequencies as well as the spatial subchannels.

Embodiments of the invention may be configured for various types of systems employing MIMO. FIG. 1B is a block diagram of a layered space-time MIMO system configured to employ space-time preceding. Encoded data from an FEC Coder 121 is processed by a Space-Time Coder 123 that provides precoding to spatio-temporal bins of a transmitter array 125. A code generator 126 employing a trellis-exploration algorithm is configured to produce the spatio-temporal codes used for pre-coding. A corresponding receiver comprises a receiver array 127, a matched filter 129, and an FEC decoder 131.

The code generator 126 comprises a branch-metric calculation module 171 configured for calculating branch metrics based on at least one fitness function for possible state transitions between two successive states. The code generator 126 further comprises a path-selection module 172 configured for calculating, as a function of the branch metrics, path metrics for possible paths constituted by successive state transitions that end in each of the states. The path-selection module 172 is configured for selecting, for each of the states, the path having the optimal path metric. This optimal path dictates the spatio-temporal codes.

FIG. 1C illustrates a MIMO system configured to perform eigenmode transmission. A transmitter comprises an FEC coder 141, a spatial processor 143, a code generator 146 coupled to the spatial processor 143, and a transmitter array 145. A receiver comprises a receiver array 147, a spatial processor 149, and an FEC decoder 151.

The code generator 146 comprises a branch-metric calculation module 181 configured for calculating branch metrics based on at least one fitness function for possible state transitions between two successive states. The code generator 146 further comprises a path-selection module 182 configured for calculating, as a function of the branch metrics, path metrics for possible paths constituted by successive state transitions that end in each of the states. The path-selection module 182 is configured for selecting, for each of the states, the path having the optimal path metric. This optimal path dictates the pre-coding code sets used to spread data across the transmitter array 145.

In general, up to N_{S} data streams may be transmitted simultaneously from the N_{T} transmit antennas in the MIMO system. However, these data streams interfere with each other at the receive antennas. Improved performance may be achieved by transmitting data on N_{S} eigenmodes of the MIMO channel, where the eigenmodes may be viewed as orthogonal spatial channels. To transmit data on the N_{S} eigenmodes, it is necessary to perform spatial processing at both the transmitter and the receiver. The spatial processing attempts to orthogonalize the data streams so that they can be individually recovered with minimal degradation at the receiver.

For data transmission on the N_{S} eigenmodes, the transmitter performs spatial processing with a matrix of N_{S} eigenvectors, one eigenvector for each eigenmode used for data transmission. Each eigenvector contains N_{T} complex values used to scale a data symbol prior to transmission from the N_{T} transmit antennas and on the associated eigenmode. For data reception, the receiver performs receiver spatial processing (or spatial matched filtering) with another matrix of N_{S} eigenvectors. The eigenvectors for the transmitter and the eigenvectors for the receiver may be derived based on a channel response estimate for the MIMO channel between the transmitter and receiver. The derivation of the eigenvectors is computationally intensive. Furthermore, the accuracy of the eigenvectors may have a large impact on performance.

For a single subcarrier in a MIMO-OFDM system, the MIMO channel formed by the N_{T} transmit antennas at the transmitting entity and the N_{R} receive antennas at the receiving entity may be characterized by an N_{R}×N_{T} channel matrix H (having N_{R} rows and N_{T} columns) comprising elements hᵢⱼ, for i=1 . . . N_{R} and j=1 . . . N_{T}, denotes the coupling or complex gain between transmit antenna j and receive antenna i. For simplicity, embodiments of the invention are shown with the assumption that the MIMO channel is full rank (i.e., N_{S}=N_{T}≧N_{R}).

The channel matrix H comprises a spatial processing (or pre-coding matrix) and a spatial-matched filtering matrix, in addition to a channel-response matrix that characterizes spatial correlations between the transmitter array and the receiver array. The singular value decomposition of the channel matrix H may be expressed as:

H=UΣV^{H},

where U is an N_{R}×N_{R} unitary matrix of left eigenvectors of H, Σ is an N_{R}×N_{T} diagonal matrix of singular values of H, and V is an N_{T}×N_{T} unitary matrix of right eigenvectors of H.

The right eigenvectors of H (which are the columns of V) may be used as a matrix of steering vectors for spatial processing by the transmitting array 145 to transmit data on the N_{S} eigenmodes of H. The left eigenvectors of H (which are the columns of U) may be used for spatial matched filtering by the receiving array 147 to recover the data transmitted on the N_{S} eigenmodes. The eigenmodes may be viewed as orthogonal spatial channels obtained through decomposition. The diagonal elements of Σ are referred to as the singular values of H and represent the channel gains for the N_{S} eigenmodes of H. Diagonalization may be achieved by performing either singular value decomposition of the channel response matrix H or eigenvalue decomposition of the correlation matrix of H. The eigenvalue decomposition of the correlation matrix is:

R=H^{H}H=VΛV^{H},

where Λ is an N_{T}×N_{T} diagonal matrix of eigenvalues of R that represent power gains for the N_{S} eigenmodes of H.

Eigenmode transmission refers to transmission of data on the N_{S} eigenmodes of the MIMO channel. Eigenmode transmission requires spatial processing by both the transmitter and the receiver. The spatial processing at the transmitter for eigenmode transmission on subband k may be expressed as:

x(k)=V(k)s(k),

where s(k) is an N_{T}×1 data vector with N_{S} non-zero entries for N_{S} modulation symbols to be transmitted on the N_{S} eigenmodes for subband k; and x(k) is an N_{T}×1 transmit vector with N_{T} entries for N_{T} transmit symbols to be sent from the N_{T} transmit antennas for subband k.

The received symbols obtained by the receiver for subband k may be expressed as:

r(k)=H(k)×(k)+n(k)=H(k)V(k)s(k)+n(k),

where r(k) is an N_{R}×1 received vector with N_{R} entries for N_{R} received symbols obtained via the N_{R} receive antennas for subband k; and n(k) is a noise vector for subband k. The spatial processing, or matched filtering, at the receiver to recover the data vector s(k) may be expressed as:

$$\begin{matrix}\hat{s} = {Λ}^{- 1} {V}^{H} {H}^{H} r \\ = {Λ}^{- 1} {V}^{H} {H}^{H} ( HVs + n ) \\ = s + \tilde{n} ,\end{matrix}$$

where ŝ is an N_{T}×1 estimated data vector with up to N_{S} recovered data symbols, V^{H}H^{H} represents a matched filter, Λ⁻¹ is a normalizing factor, and ñ is a vector of post-processed noise.

This indicates that the N_{S} data symbol streams s(k), distorted only by post-processed channel noise, may be obtained with ideal spatial processing at both the transmitter and the receiver. However, this result assumes that both the transmitter and the receiver have perfect information about the MIMO channel. In a practical system, both the transmitter and the receiver have noisy estimates of the MIMO channel and/or noisy estimates of the eigenvectors and eigenvalues. Thus, in a practical system, the recovered data symbols for each stream will be corrupted by cross-talk from the other streams:

ŝ=s+c+ñ,

where c is a vector of cross-talk terms generated by off-diagonal terms \hat{V}^{H}Ĥ^{H}H\hat{V}, \hat{V} denotes an estimate of V, and Ĥ is an estimate of H.

One embodiment of the invention provides for employing an asymptotically optimal decoding algorithm (such as a trellis-exploration algorithm similar to a Viterbi Algorithm) to update the estimated spatial-processing matrix \hat{V}. Branch metrics are calculated based on at least one fitness function for possible state transitions between two successive states. A fitness function may comprise a measure of orthogonality between the spatial subchannels. Path metrics are calculated from the branch metrics for possible paths constituted by successive state transitions and ending in each of the states. For each state, the path having an optimal path-metric value is selected.

A trellis-exploration algorithm may be employed for updating the spatial-processing matrix \hat{V} once the spatial processing matrix has been estimated via some alternative means, such as a singular value decomposition. In one embodiment of the invention, a low-complexity method may be employed for generating an initial rough estimate of the spatial-processing matrix \hat{V}, followed by performing updates via asymptotically optimal decoding. In another embodiment, asymptotically optimal decoding may be employed for updating the spatial-processing matrix \hat{V} in response to changes in operating parameters that affect spatial processing. For example, updates may be made in response to changing channel conditions, changes in the number of spatial channels to N_{S}, or any other factors that impact correlations between spatial subchannels. In yet another embodiment, an asymptotically optimal decoding algorithm may be employed for deriving \hat{V} without first performing a singular value decomposition. In alternative embodiments of the invention, the fitness function may comprise multiple objectives for pre-coding selection, including spreading to reduce PAPR.

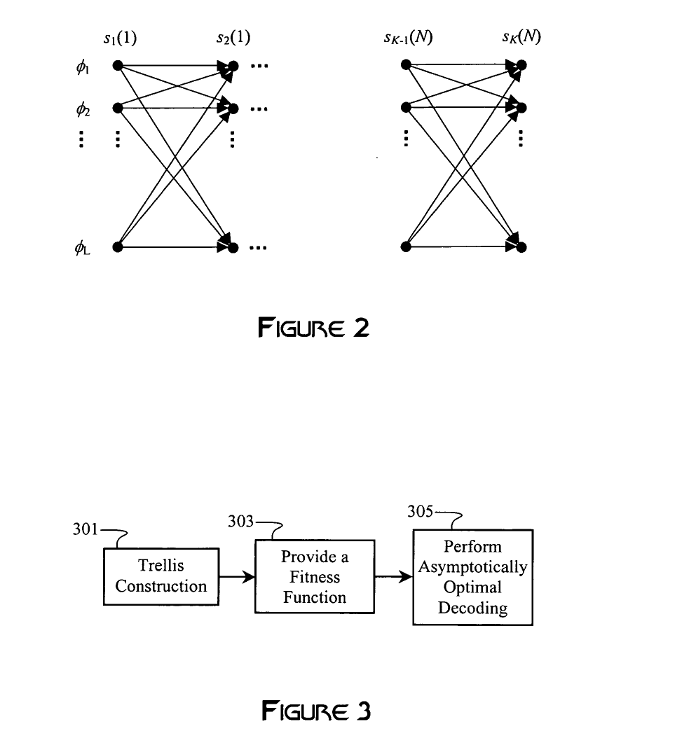

A trellis shown in FIG. 2 illustrates a functional embodiment of the invention that may be performed by the code generators 106, 126, and 146. The trellis comprises K×N state transitions, with each transition point having L nodes. K is the number of spatial subchannels transmitted by the N-element transmitter array for a particular frequency subchannel, and L is the number of discreet phases φ, discreet amplitudes, or phase-amplitude combinations used in the spreading matrix S. Each transition point sₖ(n) corresponds to a precoding matrix element for an n^{th} transmit antenna and a k^{th} symbol value bₖ. In one embodiment, the transition points sₖ(n) are arranged as {s₁(1), s₂(1), . . . , s_{K-1}(N), s_{K}(N)}, which is shown in FIG. 2. In another embodiment, the transition points sₖ(n) may be arranged as {s₁(1), s₁(2), . . . , s_{K}(N−1), s_{K}(N)}. Alternative embodiments may employ different orderings of the transition points.

FIG. 3 illustrates an exemplary method embodiment of the invention configured for calculating and/or updating a precoding code set employed for spreading data across a transmitter array. Embodiments of the invention may employ various types of asymptotically optimal decoding algorithms, which are well-known in the art, including variations of the algorithm disclosed by Viterbi in “Error bounds for convolutional codes and an asymptotically optimal decoding algorithm”, IT, Vol. 13, 1967, pp. 260-269. In the prior art, Viterbi's algorithm is implemented as a maximum likelihood estimation, which provides an optimization with respect to an error-measurement metric (e.g., bit-error rate). However, embodiments of the invention may employ a trellis-exploration type of a maximum likelihood algorithm 305 to provide an estimate of one or more pre-coding code sets based on a corresponding preferred path metric. This estimation may be weighted if necessary.

Trellis construction 301 is performed for a predetermined number K of desired subchannels (such as spatial subchannels, space-frequency subchannels, and spatio-temporal subchannels), at least one predetermined code length N, and a number L of precoding code values. The code values may include any combination of signal phase, signal amplitude, or any other measurable signal parameter that may be employed for multiple access. Exemplary embodiments of the invention are described in J. S. Dyer and B. Natarajan, “A Low-Complexity Deterministic Algorithm for DS-CDMA Sequence Generation,” VTC Fall 2005, Sep. 25-28, 2005, and J. S. Dyer and B. Natarajan, “A New Deterministic Algorithm for DS-CDMA Signature Sequence Generation,” ICC 2005, May 16-20, 2005, which are hereby incorporated by reference.

In one embodiment of the invention, a trellis having K×N state transitions (such as illustrated in FIG. 2) is constructed based on the number of desired subchannels or codes K in the system, the desired code length N, and a number L of discrete (unique) phases φ₁, . . . , φ_{L} to be used in the code set. One of ordinary skill in the art will appreciate that a trellis can be regarded as a representation of computational procedures performed by a signal-processing module comprising a combination of hardware and software components. Thus, trellis parameters and other characteristics may be embodied within algorithms, computational processes, and even hardware employed by the present invention.

The trellis includes K×N state transitions, wherein each transition point is characterized by L nodes, or states. Each transition point may correspond to a particular element (i.e., code chip) for a given code set. For example, a sequence of transition points in a lattice may correspond to elements of a particular code set having the following order

{u₁(1), u₂(1), . . . , u_{K-1,}(N), u_{K}(N)}

where uₖ(n) corresponds an n^{th} element of a k^{th} subchannel's code. This topology may be classified as a by-element variant since a code-chip value is assigned to the n^{th} element of each k^{th} subchannel's code before proceeding to the (n+1)^{th} element.

In an alternative embodiment of the invention, the trellis may be constructed with a code set ordered as

{u₁(1), u₁(2), . . . , u_{K,}(N−1), u_{K}(N)}

This variant will be referred to as the by-subchannel variant, since an entire subchannel's code is assigned before proceeding to the assignment of elements of the next subchannel's code. In general, these two variants may provide slightly different final code sets that have similar cross-correlation characteristics.

The scope of the invention should not be interpreted as being limited to the type of ordering illustrated in the embodiments. Rather, the Applicants anticipate that alternative code-set orderings may be implemented, and that such orderings fall within the scope and spirit of the invention.

Interconnects may be made between each of the L nodes (e.g., nodes φ₁, . . . , φ₄) at a transition point p to each of the L nodes of an adjacent transition point p+1. Although the illustrated trellis suggests that an equal number L of nodes exists for each transition point and that each node has L possible interconnects, it should be appreciated that the number of nodes L and the number of possible interconnects may differ between embodiments. For example, certain embodiments of the invention may provide for reducing the number of possible interconnects. Some embodiments of the invention may also vary the number of nodes L in the lattice.

The L nodes correspond to L candidate spatial preceding values, or elements, vₗ, where l ε {1, . . . ,L}. In one exemplary embodiment of the invention, polyphase code-chip values φ₁, . . . , φ_{L} may be employed. Thus, the candidate code-chip values vₗ=φₗ may be expressed as

$${φ}_{l} = exp ( \frac{2 π l}{L} ) .$$

In alternative embodiments of the invention, alternative selections of phases φ₁, . . . , φ_{L} may be employed. Embodiments of the invention may provide for complex-valued codes that include a non-uniform amplitude component. Code-chip values employed herein may alternatively comprise only a variable-amplitude component. Further variations of the invention may provide for different code-chip constellations for different transition points. For example, phase-rotated sets of complex code-chip values may be provided relative to each transition point.

For each node at a transition point in the trellis, a path terminating at one of the nodes of the previous transition point is selected based on a predetermined fitness function 203. In one exemplary embodiment, the fitness function may comprise an average mean-square aperiodic cross correlation R_{CC} of the codes. However, alternative correlation functions (as well as other fitness functions) may be employed. For example, a spectral correlation function may be used in systems employing spreading in the frequency domain. An aperiodic autocorrelation may be used for reducing peak-to-average-power ratio (PAPR). Alternatively, the fitness function may use a Fourier transform of an aperiodic autocorrelation to shape a code's power spectral density, which may be advantageous for interference and jammer avoidance.

In a spatio-temporal system, the average mean-square cross correlation R_{CC} is described mathematically as

$${R}_{CC} = \frac{1}{K ( K - 1 ) {N}^{2}} {\sum }_{x = 1}^{K} {\sum }_{y = 1 , \\ y \neq x}^{K} {\sum }_{l = 1 - N}^{N - 1} {α}_{l} {\vert {C}_{xy} ( l ) \vert}^{2} ,$$

where K is the number of spatio-temporal channels, C_{xy}(l) is the aperiodic correlation function between two codes corresponding to a multipath delay of l, and αₗ is a complex-valued scaling factor for the l^{th} multipath. The term C_{xy}(l) is expressed by

$${C}_{xy} ( l ) = \{ \begin{matrix}{\sum }_{k = 0}^{N - 1 - l} {u}_{x} ( k ) {u}_{y}^{*} ( k + l ) & 0 \leq l \leq N - 1 \\ {\sum }_{k = 0}^{N - 1 + l} {u}_{x} ( k - l ) {u}_{y}^{*} ( k ) & 1 - N \leq l \leq 0 \\ 0 & otherwise\end{matrix}$$

where uₓ and u_{y} represent pre-coding code sets for a subchannel x and a subchannel y, respectively. It is customary to normalize R_{CC} relative to code length to facilitate comparisons between codes of different lengths.

A mean-square measure for autocorrelation is given by

$${R}_{AC} = \frac{1}{{KN}^{2}} {\sum }_{x = 1}^{K} {\sum }_{l = 1 - N , \\ l \neq 0}^{N - 1} {α}_{l} {\vert {C}_{xx} ( l ) \vert}^{2}$$

A relationship between R_{CC} and R_{AC} is given as follows:

R_{AC}>(K−1)(1−R_{CC})

### Thus, the maximum-square aperiodic cross-correlation profile may be represented as the maximum value of the cross-correlations between signature sequences of any two subchannels at some relative offset

Rₘₐₓ(l)=max(|C_{xy}(l)|²) ∀ x,y ε {1, . . . , K},

which is defined for all relative delays l. An absolute maximum-square aperiodic cross correlation R_{Max} is defined as the maximum value of Rₘₐₓ(l) over all l. Thus, R_{Max} represents a worst-case BER than can occur due to MAI.

In a MIMO-OFDM embodiment employing adequate cyclic prefixes or guard intervals, the sum over multipaths may be removed. In a space-frequency embodiment with cyclic prefixes and spreading across OFDM subcarriers, the sum over multipaths may be replaced by a sum over subcarriers. Some embodiments of the invention may be configured to produce code sets characterized by a predetermined relationship between R_{Max}, R_{AC}, and R_{CC}.

In an exemplary embodiment of the invention, each node at a transition point p may be joined to a path terminating at one of the nodes of the previous transition point (p-1). Selection of a “winning” path is performed by appending the code value corresponding to the particular node at transition point p to a code sequence corresponding to a path terminating at transition point p-1 based on the predetermined fitness function. A candidate path ending at transition point p-1 may be selected more than once by nodes at point p. Accordingly, one or more candidate paths at point p-1 may not be selected, and thus, can be removed from consideration. Thus, for each transition point, there are L active paths. Some embodiments of the invention may be configured to provide an approximation to the fitness function, such as by employing only a portion of the total K×N code-set matrix.

Various embodiments of the invention may provide for different decision mechanisms, such as when more than one candidate path in the trellis achieves the same minimum value of R_{CC} for the current node under consideration. Typically, the decision rule in convolutional decoding and MLSE reception has been to follow a pre-defined convention, such as selecting the first path encountered with the minimum value of the error function. However, certain embodiments of the invention may have many instances in which multiple paths achieve the same R_{CC} at a particular node. In these cases, employing a typical prior-art decision rule may substantially limit the code-set search space. Accordingly, embodiments of the invention may implement a deterministic decision rule. For example, the decision rule may be configured to select a path from the set of all paths having the minimum R_{CC} value such that:

p=(k+n+l+i)mod T

where p is the selected index among the set of paths having the minimum R_{CC}, k is the subchannel associated with the particular code-set element currently being evaluated, n is the index into the code for the code-set element currently under consideration, l is the index of the candidate phase, i is the number of iterations through the trellis at the present time, and T is the number of elements in the set of paths reaching the minimum R_{CC}. This exemplary decision rule can step sequentially through the paths with respect to indices k, n, l, and i. Thus, if for a particular k, n, and l, there are the same number of elements in the set of minimum-R_{CC} paths from one iteration to the next, the algorithm will step through them sequentially over each iteration, giving each path the opportunity to be selected. This same property exists for each of the other three parameters as well, thus, introducing the needed diversity while also being deterministic and, therefore, repeatable over independent executions of the algorithm.

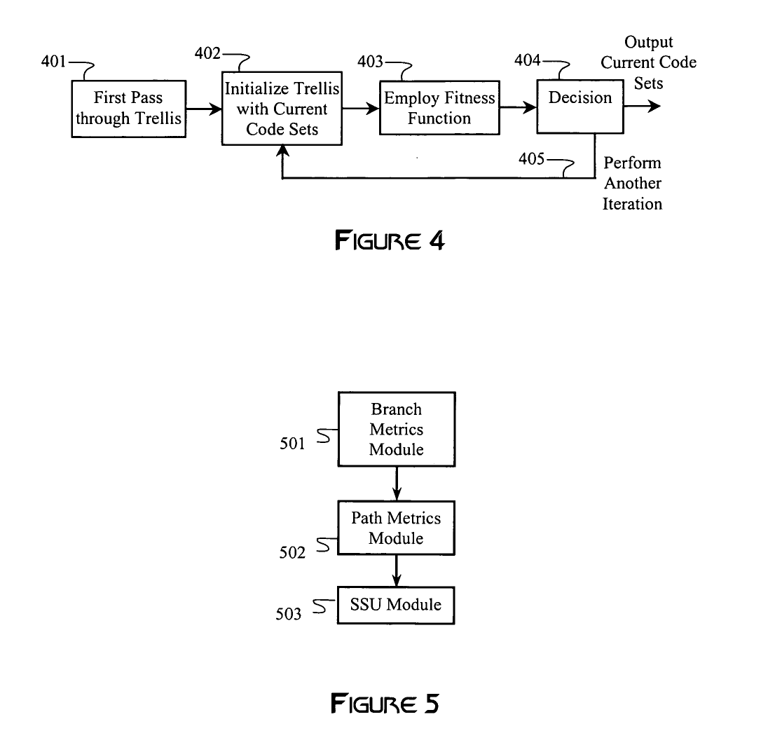

FIG. 4 illustrates a method embodiment of the invention employing multiple iterations through a trellis. Embodiments of the invention may employ iterative decoding techniques (such as described in Q. Wang and L. Wei, “Graph-Based Iterative Decoding Algorithms for Parity-Concatenated Trellis Codes, ” IEEE Trans. Information Theory, Volume: 47 Issue: 3, March 2001 Page(s): 1062-1074, which is hereby incorporated by reference) for generating multiple-access codes.

In a first pass through the trellis 401, the first N-1 elements (e.g., spatial code values) of each subchannel code may be selected based on incomplete information because the calculation of the fitness function does not employ subsequent code values that are determined later. Thus, an optimal path may not be selected during the first pass. One embodiment of the invention may be configured to compensate for this problem by providing for multiple iterations (i.e., traversals) through the trellis. When the first pass 401 through the trellis is completed, L complete candidate code sets have been built. The trellis is initialized 402 with the current code sets, which are then used in the fitness function 403. The fitness function 403 is used to calculate branch metrics. Thus, the implementation of the fitness function for the first N−1 elements of each subchannel's code set can exploit the full code-set length N.

Each subsequent iteration 405 through the trellis causes the fitness function to asymptotically approach an optimal (e.g., minimum) value. Typically, a saturation point is reached after a certain number of iterations. A decision process 404 may be provided for determining whether to repeat the trellis operations 402 and 403 or output the current code sets. Such determinations are typically made with respect to an evaluation of the metrics and/or a count of the number of iterations performed.

A trellis-exploration algorithm, such as Viterbi decoding, may be broken down into metric update and traceback operations. In metric update, an accumulated state metric is calculated for each state and the optimal incoming path associated with each state is determined. Traceback uses this information to derive an optimal path through the trellis.

Some embodiments of the invention may employ multi-objective versions of an asymptotically optimal decoding algorithm. In one embodiment, metrics used to evaluate the multiple objectives may be combined into a single metric. For example, if it is desirable to evaluate two objectives f(U) and g(U), where U denotes the code matrix. A combined objective function h(f(U); g(U)) may be used to evaluate each node of the trellis.

An alternative embodiment may be based on Pareto optima. The Pareto optima are the subset of a population for which no other individual element in the population has superior characteristics in all objectives under consideration. The first iteration is completed 401 in order to provide a complete code set U for initializing the trellis 402. At each stage or node of the trellis, the fitness function 403 involves deterministically selecting one of the objectives as the evaluation metric for that stage or node, respectively. An optimal path under the chosen metric is selected at each node as part of the decision process 404.

The decision process 404 may maintain a table of the Pareto optima by considering each of the objectives at a particular node, and if one is found that belongs to the set of Pareto optima, it is added to the table of Pareto optima. Thus, the decision process 404 may include comparing the metrics of each candidate path to those of each element of the Pareto optima. If a particular element of the Pareto optima is better in every metric than the candidate path, then the candidate path is discarded because it cannot belong to the set of Pareto optima. If none of the Pareto optima elements dominates a candidate path, then the candidate path is added to the table. Any elements of the current Pareto optima that are dominated by the candidate path are subsequently deleted.

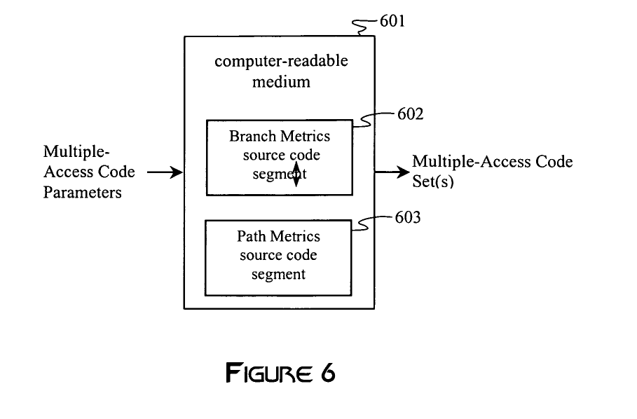

FIG. 5 shows a block diagram of a pre-coder according to one embodiment of the invention. A branch metrics module 501 is configured for computing a branch metric for a code-chip candidate corresponding to each of the possible transitions (i.e., code-chip values). An accumulated metrics module, or a path metrics module 502, is configured to operate at each node of the trellis to add branch metrics to one or more former path metrics, compare the new path metrics, and select at least one new optimum path metric. A survivor storage and updating (SSU) module 503 may be configured to store decisions (also called “survivors”) coming from the accumulated metrics module and provide a trace-back of the paths, such as is well-known in the art of Viterbi decoding.

It should be appreciated that the pre-coder shown in FIG. 5, as well as method embodiments of the invention, may be implemented using a variety of hardware and software. For example, portions of the pre-coder may be implemented using special-purpose hardware, such as an application specific integrated circuit (ASIC) and programmable logic devices such as gate arrays, and/or software or firmware running on a computing device, such as a microprocessor, microcontroller or digital signal processor (DSP). It also will be appreciated that although functions of the pre-coder may be integrated in a single device, such as a single ASIC, they may also be distributed among several devices.

FIG. 6 shows software components of a coding embodiment of the invention residing on a computer-readable memory 601. A branch-metrics module 602 is adapted to receive as input one or more multiple-access code parameters, such as code length, number of codes and/or users, and at least one constellation of possible code-chip values. The branch-metrics module 602 is configured for calculating branch metrics for each possible state transition between two successive states. The branch-metrics module 602 may be configured to produce and/or calculate a fitness function based on an asymptotically optimal decoding algorithm (such as a trellis-exploration algorithm similar to a Viterbi algorithm) to provide for constructing a multiple-access code set. Furthermore, the branch-metrics module 602 may construct a trellis.

A path-metrics module 603 is configured for calculating path metrics for possible paths, which result from successive state transitions. For each node in a state, the path-metrics module 603 may be further configured to select a path having an optimal path-metric value and output at least one multiple-access code set corresponding to a set of optimal paths. The branch-metrics module 602 and the path-metrics module 603 may be configured to perform multiple iterations through a trellis.

A dramatic reduction of the total algorithmic complexity can be achieved by exploiting certain properties of the trellis, as well as those of the cross-correlation operation used to compute R_{CC}. It is quite straightforward to see that there are V=L²NK function evaluations for each iteration through the trellis.

To calculate R_{CC}, it is typically necessary to perform K(K−1)/2 aperiodic cross correlation operations of complex-variable vectors of length N. Assuming that a Fast Fourier Transform (FFT) approach is taken to compute each of these correlations, the complexity of the function evaluation in terms of complex multiplication and additions (MADs) is O((N log N)K²), which must be computed V times, leading to an overall complexity of O(L²(N² log N)K³).

Particular embodiments of the invention may be configured to reduce the overall complexity. For example, for each candidate phase at each stage of the trellis, a single element is appended to a single subchannel's code and R_{CC} is recalculated. This single element can be shown to affect the cross-correlation matrix in exactly N locations of each of the (K−1) cross-correlations between that subchannel and every other subchannel (disregarding autocorrelations). Thus, a simplification of this algorithm may involve maintaining a cross-correlation matrix Aₗ for each candidate path through the trellis and updating the matrix Aₗ by adding the effects of the current candidate phase at the corresponding N(K−1) locations and summing the new result to get the new value of R_{CC}. The simplified algorithm repeats this procedure V times, resulting in a total computational complexity of only O(L²N²K²).

The aperiodic cross-correlation between two subchannel codes, uₓ and u_{y} is given by

C_{xy}=(C_{xy}(1−N), . . . , C_{xy}(N−1))^{T}

where C_{yx} is simply the mirror image of C_{xy}. The R_{CC} metric is based on the accumulated moduli of the aperiodic cross-correlation values at each tap delay, and for each pair of subchannels (x, y), it is sufficient to consider only one of C_{xy} and C_{yx}. Thus, the aperiodic cross-correlation matrix Aₗ has a size K(K−1)/2×(2N−1), where l denotes the index of the path to which it corresponds. The matrix Aₗ has row entries

Aₗ=(C₁₂^{T}, C₁₃^{T}, . . . , C_{1K}^{T}, C₂₃^{T}, . . . , C_{K-1,K}^{T})^{T}

such that, for every code pair (x, y), there is no corresponding pair (y, x).

Upon appending element uₓ(m) to a current path through the trellis, the following algorithm may be used to update the corresponding cross-correlation matrix Aₗ

Algorithm 1: Low-complexity R_{cc} update

Require: A₁, U and new element uₓ(m)
Ensure: one-indexing

for ∀y < x do

$k ← ( y - 1 ) ( K - 1 ) - \frac{[ g - 1 ] [ g - 2 ]}{2} + ( x - y )$
for p = m to m + N − 1 do

A₁(k,p) ← A₁(k, p) + u_{g}(p − m + 1)uₓ*(m)

end for

end for
for ∀y > x do

$k ← ( x - 1 ) ( K - 1 ) - \frac{[ x - 1 ] [ x - 2 ]}{2} + ( y - x )$
for p = N − m + 1 to 2N − m do

A₁(k, p) ← A₁(k, p) + u_{y}*(2N − m + 1 −

p)uₓ(m)

end for

end for

There are two notable differences between the two for loops. The first loop uses the conjugate of the newly-appended element, uₓ(m), whereas the second loop uses the conjugate of the code entries from the other subchannels' codes. Secondly, the algorithm loops through the elements of each u_{y} in forward order in the first loop and in reverse order in the second loop. To calculate the new value for R_{CC}, it is necessary to subtract out the moduli of the affected elements before performing the update algorithm, and then add in the moduli of the affected elements after the algorithm is run. Thus, this full update algorithm has complexity O(NK), since there are N(K−1) elements affected in each of these operations. In contrast, conventional computational-intelligence approaches recalculate the entire R_{CC} metric for each function evaluation, resulting in a complexity of O((N log N)K²).

Variations of the previously disclosed embodiments may be provided for reducing computational complexity. For example, the relationship

$${\sum }_{k = 0}^{K - 1} {\sum }_{m = 0}^{K - 1} ( {\sum }_{1 = 1 - N}^{N - 1} {\vert {C}_{m , k} ( l ) \vert}^{2} ) = {K}^{2} {N}^{2} + 2 {\sum }_{l = 1}^{N - 1} {\vert {\sum }_{k = 0}^{K - 1} {C}_{k , k} ( l ) \vert}^{2}$$

may be exploited to produce the equation

$${R}_{CC} = 1 - \frac{{R}_{AC}}{K - 1} + \frac{2}{{KN}^{2} ( K - 1 )} {\sum }_{l = 1}^{N - 1} {\vert {\sum }_{k = 0}^{K - 1} {C}_{k , k} ( l ) \vert}^{2} .$$

Thus, in order to calculate both R_{AC} and R_{CC}, it is only necessary to consider the aperiodic autocorrelation matrix. At a particular stage of the trellis, a single element of a single subchannel's code affects only one row of the aperiodic autocorrelation matrix. Furthermore, since the aperiodic autocorrelation is symmetric about zero lag, and the autocorrelation at zero lag is ignored in the previous equation, it is sufficient to consider only positive lags.

The last term in the previous equation simply consists of the moduli of the sums of the complex-valued aperiodic autocorrelations at a particular lag for each subchannel. Thus, at each stage of the trellis, an algorithm in accordance with one embodiment of the invention may calculate the new aperiodic autocorrelation for a single subchannel. The algorithm may keep a separate N−1 length vector of summed columns of the aperiodic autocorrelation matrix, since only these N−1 complex values need to be updated. The moduli of the updated complex values are summed to calculate an updated R_{CC} metric.

In this embodiment, an update of the R_{CC} metric requires only O(N) complex MADs at each stage of the trellis (N complex MADs to update the aperiodic autocorrelation matrix and N complex additions and norm calculations, followed by an N-length real-valued summation). The computational complexity of this algorithm is O(L²N²K). This algorithm also provides a reduced memory overhead of O(LNK), since it does not require storing matrix Aₗ for its implementation, but rather, needs only to store the aperiodic autocorrelation matrix, plus an additional N−1 length vector for each active trellis path.

The invention is not intended to be limited to the preferred embodiments. Furthermore, those skilled in the art should recognize that the method and apparatus embodiments described herein may be implemented in a variety of ways, including implementations in hardware, software, firmware, or various combinations thereof. Examples of such hardware may include ASICs, Field Programmable Gate Arrays, general-purpose processors, DSPs, and/or other circuitry. Software and/or firmware implementations of the invention may be implemented via any combination of programming languages, including Java, C, C++, Matlab™, Verilog, VHDL, and/or processor specific machine and assembly languages.

Computer programs (i.e., software and/or firmware) implementing the method of this invention may be distributed to users on a distribution medium, such as a SIM card, a USB memory interface, or other computer-readable memory adapted for interfacing with a wireless terminal. Similarly, computer programs may be distributed to users via wired or wireless network interfaces. From there, they will often be copied to a hard disk or a similar intermediate storage medium. When the programs are to be run, they may be loaded either from their distribution medium or their intermediate storage medium into the execution memory of a wireless terminal, configuring an onboard digital computer system (e.g. a microprocessor) to act in accordance with the method of this invention. All these operations are well known to those skilled in the art of computer systems.

The term “computer-readable medium” encompasses distribution media, intermediate storage media, execution memory of a computer, and any other medium or device capable of storing for later reading by a digital computer system a computer program implementing the method of this invention.

Various digital computer system configurations can be employed to perform the method embodiments of this invention, and to the extent that a particular system configuration is capable of performing the method embodiments of this invention, it is equivalent to the representative system embodiments of the invention disclosed herein, and within the scope and spirit of this invention.

Once digital computer systems are programmed to perform particular functions pursuant to instructions from program software that implements the method embodiments of this invention, such digital computer systems in effect become special-purpose computers particular to the method embodiments of this invention. The techniques necessary for this programming are well known to those skilled in the art of computer systems.

Various embodiments of the invention may include variations in system configurations and the order of steps in which methods are provided. In many cases, multiple steps and/or multiple components may be consolidated.

The method and system embodiments described herein merely illustrate particular embodiments of the invention. It should be appreciated that those skilled in the art will be able to devise various arrangements, which, although not explicitly described or shown herein, embody the principles of the invention and are included within its spirit and scope. Furthermore, all examples and conditional language recited herein are intended to be only for pedagogical purposes to aid the reader in understanding the principles of the invention. This disclosure and its associated references are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be appreciated by those skilled in the art that the block diagrams herein represent conceptual views of illustrative circuitry, algorithms, and functional steps embodying principles of the invention. Similarly, it should be appreciated that any flow charts, flow diagrams, signal diagrams, system diagrams, codes, and the like represent various processes that may be substantially represented in computer-readable medium and so executed by a computer or processor, whether or not such computer or processor is explicitly shown.

The functions of the various elements shown in the drawings, including functional blocks labeled as “processors” or “systems,” may be provided through the use of dedicated hardware as well as hardware capable of executing software in association with appropriate software. When provided by a processor, the functions may be provided by a single dedicated processor, by a shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, the function of any component or device described herein may be carried out through the operation of program logic, through dedicated logic, through the interaction of program control and dedicated logic, or even manually, the particular technique being selectable by the implementer as more specifically understood from the context.

Any element expressed herein as a means for performing a specified function is intended to encompass any way of performing that function including, for example, a combination of circuit elements which performs that function, or software in any form, including, therefore, firmware, micro-code or the like, combined with appropriate circuitry for executing that software to perform the function. Embodiments of the invention as described herein reside in the fact that the functionalities provided by the various recited means are combined and brought together in the manner which the operational descriptions call for. Applicant regards any means that can provide those functionalities as equivalent to those shown herein.

1. A pre-coder configured for employing an asymptotically optimal decoding algorithm for generating spatial subchannel codes, the pre-coder comprising:
a branch-metric calculation module configured for calculating branch metrics based on at least one fitness function for possible state transitions between two successive states, and
a path-selection module configured for calculating, as a function of said branch metrics, path metrics for possible paths constituted by successive state transitions and ending in each of said states, and for selecting, for each of said states, only a path having an optimal path-metric value.

2. The pre-coder recited in claim 1, further configured for generating spatial subchannel codes comprising at least one of spatial codes, space-frequency codes, and spatio-temporal codes.

3. The pre-coder recited in claim 1, wherein the branch-metric calculation module is configured to derive the at least one fitness function as a function of eigenvalues of a channel-correlation matrix.

4. The pre-coder recited in claim 1, wherein the branch-metric calculation module is configured to derive the at least one fitness function comprising a plurality of objectives.

5. The pre-coder recited in claim 1, wherein the spatial subchannel codes comprise at least one of a set of signal parameters, the set comprising a number of discrete phases and a number of discrete amplitudes.

6. The pre-coder recited in claim 1, wherein transition points described with respect to a trellis are organized according to a by-element variant topology or a by-subchannel variant topology.

7. The pre-coder recited in claim 1, wherein each of a plurality of transition points described with respect to a trellis comprise a different number of nodes.

8. The pre-coder recited in claim 1, wherein the precoder is configured to perform a plurality of iterations through a trellis.

9. The pre-coder recited in claim 8, wherein the precoder is configured to determine the plurality of iterations from at least one of a set comprising a predetermined number and an evaluation of metrics.

10. A pre-coding method configured for employing an asymptotically optimal decoding algorithm for generating spatial subchannel codes, the method comprising:
providing for calculating branch metrics based on at least one fitness function for possible state transitions between two successive states, and
providing for calculating, as a function of said branch metrics, path metrics for possible paths constituted by successive state transitions and ending in each of said states, and for selecting, for each of said states, only a path having an optimal path-metric value.

11. The method recited in claim 10, further configured for generating the spatial subchannel codes comprising at least one of spatial codes, space-frequency codes, and spatio-temporal codes.

12. The method recited in claim 10, wherein providing for calculating branch metrics is configured to derive the at least one fitness function as a function of eigenvalues of a channel-correlation matrix.

13. The method recited in claim 10, wherein providing for calculating branch metrics is configured to derive the at least one fitness function comprising a plurality of objectives.

14. The method recited in claim 10, wherein the spatial subchannel codes comprise at least one of a set of signal parameters, the set comprising a number of discrete phases and a number of discrete amplitudes.

15. The method recited in claim 10, wherein transition points described with respect to a trellis are organized according to a by-element variant topology or a by-subchannel variant topology.

16. The method recited in claim 10, wherein each of a plurality of transition points described with respect to a trellis comprise a different number of nodes.

17. The method recited in claim 10, further configured to perform a plurality of iterations through a trellis.

18. The method recited in claim 17, further configured to determine the plurality of iterations from at least one of a set comprising a predetermined number and an evaluation of metrics.

19. A computer program residing on a computer-readable memory configured to perform the method recited in claim 10.

20. A digital computer system programmed to perform the method recited in claim 10.

21. A pre-coding system configured for employing an asymptotically optimal decoding algorithm for generating spatial subchannel codes, the method comprising:
a branch-metric calculation means configured for calculating branch metrics based on at least one fitness function for possible state transitions between two successive states, and
a path-metric calculation means configured for calculating, as a function of said branch metrics, path metrics for possible paths constituted by successive state transitions and ending in each of said states, and for selecting, for each of said states, only a path having an optimal path-metric value.

22. The system recited in claim 21, further configured for generating the spatial subchannel codes comprising at least one of spatial codes, space-frequency codes, and spatio-temporal codes.

23. The system recited in claim 21, wherein the branch-metric calculation means is configured to derive the at least one fitness function as a function of eigenvalues of a channel-correlation matrix.

24. The system recited in claim 21, wherein the branch-metric calculation means is configured to derive the at least one fitness function comprising a plurality of objectives.

25. The system recited in claim 21, wherein the spatial subchannel codes comprise at least one of a set of signal parameters, the set comprising a number of discrete phases and a number of discrete amplitudes.

26. The system recited in claim 21, wherein transition points described with respect to a trellis are organized according to a by-element variant topology or a by-subchannel variant topology.

27. The system recited in claim 21, wherein each of a plurality of transition points described with respect to a trellis comprise a different number of nodes.

28. The system recited in claim 21, further configured to perform a plurality of iterations through a trellis.

29. The system recited in claim 28, further configured to determine the plurality of iterations from at least one of a set comprising a predetermined number and an evaluation of metrics.
